(19) United States
(12) Patent Application Publication
(10) Pub. No.: US 2025/0320361 A1
(43) Pub. Date: Oct. 16, 2025

(54) BIODEGRADABLE WAX-BASED COMPOSITION AND ITS USE IN ABIODEGRADABLE FUNERAL URN

(71) Applicant: Ignacio Augusto Carreras, Tandil (AR)

(72) Inventor: Ignacio Augusto Carreras, Tandil (AR)

(21) Appl. No.: 18/634,709

(22) Filed: Apr. 12, 2024

(51) Int. Cl. C08L 91/06; A61G 17/08; C08L 97/00

(52) U.S. Cl. CPC C08L 91/06; A61G 17/08; C08L 97/00; C08L 2201/06

(57) ABSTRACT

A composition useful for the preparation of a biodegradable material, in which its components are environmentally friendly. The composition comprises: 20 to 100 wt. % of environmentally friendly wax; 0 to 80 wt. % of environmentally friendly particles; and 0 to 20 wt. % of oils, essential oils, natural dyes or natural flavorings. The use of such composition as a material for biodegradable articles, such as a Funeral Urn.

### FIELD OF THE INVENTION

The present invention relates to a biodegradable composition based on wax and its use in a biodegradable funeral urn.

In addition, the present invention provides improved materials for the formation of degradable objects (for example, biodegradable funeral urns), produced using wax and environmentally friendly materials.

A use of the biodegradable wax-based composition, to provide at least a part of a biodegradable object. Said object is for example a biodegradable funeral urn.

The present invention relates to a biodegradable funeral article, more particularly to cremation urns to contain cremated human or pet remains.

Additionally, the present invention relates to a biodegradable funeral urn, which keep the roots of a plant separated from the ash until the plant develops and can safely absorb the nutrients present in the cremation ashes.

### BACKGROUND OF THE INVENTION

Cremation is a growing trend in the United States. In 2022, 59 percent of Americans who passed away were cremated. This trend is driven by several factors, including religious beliefs, cost savings, and environmental concerns.

There are various options available for the disposition of cremated remains. Some people choose to scatter the ashes, while others prefer to keep them in an urn. Urns come in a variety of shapes, sizes, and materials.

Biodegradable urns are a recent innovation. These urns are designed to naturally decompose in the soil, leaving no trace. They provide a more environmentally friendly option than traditional urns, which are often made of metal or ceramic.

Sometimes, a seed or some type of plant is placed to benefit from the nutrients present in the ashes. For this purpose, some urns may include a pot to contain a seed or a young plant.

It is now known that ashes have a Ph that is harmful to a plant in its early stages of development. To neutralize this, existing options for growing a plant that benefits from the ashes encourage its mixture with a chemical compound.

There is a great need to create ceremonies that honor the life of the being that is being bid farewell, be it a person or a pet, and to generate memorable experiences for those present at such ceremonies. There is a need for the material of the funeral urns to play an important role in those unique moments. Existing urns today, from their material, only provide stimuli from the visual and/or from the texture or touch experience.

There is a need for the ashes to be deposited inside the urn, the lid to be closed in some secure way that prevents possible leaks. In the case of biodegradable urns, due to the characteristics of their material it is difficult to use screws and it is more common to use some kind of glue to secure the lid and the urn.

The following are references from the prior art that are relevant to the present invention:

The prior art in U.S. Pat. No. 2021/0212877, “POWDERED COMPOSITION, A POURABLE, WATER-CONTAINING, UNCURED BIODEGRADABLE COMPOSITION, A CURED BIODEGRADABLE ARTICLE, PREPARATION METHODS, AND USES THEREOF”, by Diane Bisson, describes a biodegradable composition of plaster and other environmentally responsible particles, used in funeral urns. This material decomposes quickly, so it is not suitable for developing an urn, bury it and place a plant or seed above the urn. The plant will access the ashes before it is sufficiently developed. Also, due to the characteristics of said material, to achieve sealing the lid and the urn it is necessary to use an additional non-toxic glue or an additional fish glue.

According to U.S. Pat. No. 2002/0032954, “Method and Apparatus for Ecological Burial”, by José Fernando Vázquez, the urn is also designed to allow a plant to grow through it, providing a living memorial to the deceased. In this technique, when the plant breaks the urn, it does so with its trunk and the ashes remain on the surface, making it difficult for the plant to absorb them.

U.S. Pat. No. 2015/0264869, which describes an “Urn and Planter Set” by Martin Steiner. The urn is made of a non-ecological material, such as ceramic or plastic. The pot is not designed to be buried in the ground and this constitutes a limit for the development of larger plants.

U.S. Pat. No. 2019/0307630, “Biodegradable Urn Planting System,” by Mark William Brewer, allows a plant to absorb the ashes. However, this patent requires the ashes to be chemically treated, that is, they are intervened without being able to preserve them in their original state.

### SUMMARY OF THE INVENTION

According to the following embodiments of the invention, at least some, preferably all, of the aforementioned drawbacks are overcome and/or some, preferably all, of the aforementioned needs are met.

The object of the present invention refers to a composition useful for the preparation of a biodegradable material, in which its components are environmentally friendly, said composition comprises:
a. 20 to 100 wt. % of environmentally friendly wax or mix of waxes;
b. 0 to 80 wt. % of environmentally friendly particles; and
c. 0 to 20 wt. % of oils, essential oils, natural dyes or natural flavorings.

Another object of the present invention refers to the aforementioned composition, where the wax material refers to a type of wax or a mixture of more than one type of natural wax, both of animal and/or vegetable origin. Such as beeswax, composed mainly of esters of fatty acids and alcohols; carnauba waxes, obtained from the Copernicia Prunifera palm that is composed of complex esters and with a high melting point; candelilla waxes derived from the Euphorbia Antisyphilitica plant; soy waxes extracted from soybean oils and other waxes such as lanolin wax, jojoba wax, fruit and seed waxes and vegetable exudate waxes. Each wax used in the composition contributes unique characteristics of texture, color, smell and melting points to said composition. Particularly noteworthy is the possibility of adding the dimension of smell to the composition that, when used for the manufacture of articles, will confer on said articles a desirable characteristic.

The wax contributes to said composition, the possibility of acting as a binder of different elements.

The wax contributes beneficial characteristics to the composition at the time of manufacturing articles, since the waste material that is normally produced in molding or machining processes can be easily reused. Even defective produced pieces can re-enter directly as material for the manufacture of a new piece.

The wax contributes beneficial characteristics to the composition at the time of manufacturing articles, since by raising its temperature above its melting point, it acquires a fluid state that allows the pouring of said composition and produce articles by molding.

The wax contributes beneficial characteristics to the articles manufactured with said composition, since under suitable storage conditions it is preserved for a prolonged period of time without losing its qualities.

Another object of the present invention refers to the aforementioned composition, where the environmentally friendly particles are selected from the group consisting preferably of seeds, cereals, coffee particles, wood chips, cocoa, coconut shavings, condiments, resins, spices and other particles of vegetable and mineral origin respectful with the environment. Each particle used in the composition contributes unique characteristics of texture, color and smell to said composition.

Another object of the present invention refers to the aforementioned composition, where the oils, essential oils, natural dyes or natural flavorings contribute unique characteristics of texture, color, smell and melting points to said composition.

Another object of the invention refers to a biodegradable material article manufactured with the composition described above.

Another object of the invention refers to a biodegradable article that comprises at least two distinct parts, at least one of these parts being a biodegradable article manufactured with the composition described above.

Another object of the invention refers to the fact that the biodegradable article, manufactured with the composition described above, is a funeral urn.

Preferably an urn that is buried next to a plant so that said plant nourishes from the ashes. That the urn is of said biodegradable composition allows it to be buried next to a plant in an environmentally friendly manner.

That the urn is manufactured with a wax-based composition, allows the compartment that contains the ashes, to keep said ashes isolated from the roots of the plant for the necessary and sufficient time for the plant to develop to the point where it is prepared to absorb said ashes in their natural state, without the need to chemically treat them.

Also, that the urn is manufactured with a wax-based composition, gives said urn a pleasant aroma suitable for rituals, memorials, religious ceremonies, and other moments related to the article.

That said urn, be manufactured with a wax-based composition, allows the ashes to be hermetically isolated from their environment by sealing between the ash container and its lid.

The urn itself, both in terms of its composition and its components, will be better understood, and the additional objects and advantages of it will become evident through the following detailed description of a preferred embodiment taken together with the attached drawings.

### BRIEF DESCRIPTION OF DRAWINGS

The invention will be explained in more detail with reference to the embodiments shown in the drawing. The drawing shows:

FIG. 1 An embodiment of a funeral urn manufactured with the composition of the invention, namely, a lower housing (1), in which said lower housing comprises an area to contain the cremated remains, and a lid (2) of said lower housing (1), in isometric view.

FIG. 2 An embodiment of a funeral urn manufactured with the composition of the invention, namely, a lower housing (1), in which said lower housing comprises an area to contain the cremated remains, and a lid (2) of said lower housing (1), in exploded isometric view.

### EXAMPLES

### Example 1: Biodegradable Composition 70 wt. % Virgin Beeswax from Operculum and 30 wt. % Dark Beeswax from Recovery

In particular, 70 grams of light yellow operculum beeswax and 30 grams of dark brown recovery beeswax were mixed.

The light yellow operculum beeswax, also known as virgin wax, is obtained from the extraction of wax that covers the cells. Meanwhile, the dark brown recovery wax, also known as dark wax, is obtained from honey frames or breeding frames.

The obtained mixture will be a composition of a brownish yellow color, with a strong smell of beeswax, melting point close to 70° C. The presence of organic matter such as cellulose from cocoons and larval remains present in the dark wax contributes to an increase in the biodegradability of the composition.

### Example 2: Biodegradable Composition of 30 wt. % Beeswax, 30 wt. % Carnauba Wax, 40 wt. % Coffee Bean

In particular, 30 grams of light yellow operculum beeswax, 30 grams of carnauba wax and 40 grams of ground coffee bean particles were mixed.

The light yellow operculum beeswax, also known as virgin wax, is obtained from the extraction of wax that covers the cells. Carnauba wax is extracted from the Copernicia Cerifera from Brazil. It is a substance that is collected from the green parts and leaves of this tree. The particles of ground coffee beans were obtained by passing them through a sieve and recovering particles with a particle size of 0.5 mm to 1 mm.

The obtained mixture will be a composition of a yellow color in which the dark particles of coffee can be appreciated, with greater shine than that obtained in example 1 contributed by the Carnauba wax, melting point close to 80° C., higher than that of example 1 thanks to the presence of carnauba wax in the composition. The coffee particles will contribute to the mixture its characteristic aroma and an increase in the biodegradability of the composition.

### Example 3: Biodegradable Composition of 97 wt. % Beeswax and 3 wt. % Lavender Essential Oil

In particular, 97 grams of light yellow operculum beeswax and 3 grams of lavender essential oil were mixed.

The light yellow operculum beeswax, also known as virgin wax, is obtained from the extraction of wax that covers the cells. Lavender essential oil is obtained by steam distillation of the Lavandula Angustifolia plant.

The obtained mixture will be a composition of a yellow color, with a melting point close to 65° C., lower than that of example 1 thanks to the presence of lavender essential oil in the composition. This presence will provide the characteristic aroma of lavender to the composition.

### Example 4: Preparation of Various Parts of a Funeral Urn

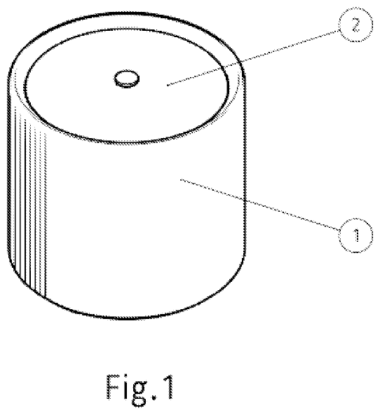

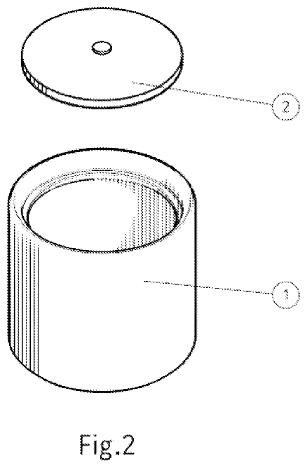

Various parts of a biodegradable funeral urn, FIG. 1 and FIG. 2, were prepared using the composition of Example 2. The temperature of this composition was increased to its melting point. In this way, a fluid state of the composition is obtained. Specifically, the biodegradable funeral urn of FIG. 1 and FIG. 2 comprises a lower housing (1), in which said lower housing comprises an area to contain the cremated remains and a lid (2) of said lower housing (1). The parts (1) and (2) are arranged to form the biodegradable funeral urn of FIG. 1.

For the molding of each part (1) and (2), the previously heated composition, in a fluid and pourable state, was poured into corresponding molds.

After the composition returns to its solid state, the parts (1) and (2) were removed from their corresponding molds.

The resulting biodegradable urn of FIG. 1, after being buried in the ground, will give several months of time to the plant located nearby to develop and, in this development, by the mechanical action of its roots, break the already partially biodegraded urn. From that moment on, the plant will take advantage of the nutrients from the ashes while the remaining fragments of the urn made with the composition of example 2, finally degrade and integrate into the soil.

1. A composition useful for the preparation of a biodegradable material, said composition comprises:
a. 20 to 100 wt. % of environmentally friendly wax or mix of waxes;
b. 0 to 80 wt. % of environmentally friendly particles; and
c. 0 to 20 wt. % of oils, essential oils, natural dyes or natural flavorings.

2. The composition of claim 1, where the wax material refers to a type of wax or a mixture of more than one type of natural wax, both of animal and/or vegetable origin. Such as beeswax, composed mainly of esters of fatty acids and alcohols; carnauba waxes, obtained from the Copernicia Prunifera palm that is composed of complex esters and with a high melting point; candelilla waxes derived from the Euphorbia Antisyphilitica plant; soy waxes extracted from soybean oils and other waxes such as lanolin wax, jojoba wax, fruit and seed waxes and vegetable exudate waxes.

3. The composition of claim 1, where the environmentally friendly particles are selected from the group consisting of seeds, cereals, coffee particles, wood chips, cocoa, coconut shavings, condiments, resins, spices and other particles of vegetable and mineral origin respectful with the environment.

4. The composition of claim 1, where the oils, essential oils, natural dyes or natural flavorings contribute unique characteristics of texture, color, smell and melting points to said composition.

5. A biodegradable material article of the composition described in claim 1.

6. A biodegradable article that comprises at least two distinct parts, at least one of these parts being a biodegradable article of the composition defined in claim 1.

7. A biodegradable funeral urn of the composition described in claim 1, that disintegrates in the soil.
